(19) United States
(12) Patent Application Publication
(10) Pub. No.: US 2004/0066474 A1
(43) Pub. Date: Apr. 8, 2004

(54) Liquid crystal display apparatus

(75) Inventors: Akira Nakano, Miyagi-ken (JP); Ken Kawahata, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/421,120

(22) Filed: Apr. 22, 2003

(30) Foreign Application Priority Data
Apr. 30, 2002 (JP) 2002-129282

(51) Int. Cl. G02F 1/1333

(52) U.S. Cl. 349/111

(57) ABSTRACT

A liquid crystal display apparatus includes a first substrate, a second substrate opposed to the first substrate, liquid crystals disposed between the first and second substrates, and a DC power supply. The first substrate has a plurality of scanning lines; a plurality of signal lines, the scanning lines and the signal lines being arranged in a matrix; display electrodes provided in the areas partitioned by the scanning lines and the signal lines; thin film transistors (TFTs) provided in the areas partitioned by the scanning lines and the signal lines and connected to the display electrodes; shield electrodes covering the respective scanning lines at least partly; and an insulating film disposed between the shield electrodes and the scanning lines. The shield electrodes are electrically connected to the DC power supply.

### BACKGROUND OF THE INVENTION

1. Field of the Invention

The present invention relates to a liquid crystal display apparatus.

2. Description of the Related Art

In a display of an active matrix liquid crystal display apparatus, a display device is formed at each intersection point of signal lines for transmitting image signals from a source driver and scanning lines for transmitting scanning signals from a gate driver.

The source driver converts the digital image signals input from the outside into analog values (voltages) corresponding to gradations of the image signals to output the converted values to the signal lines.

Each display device includes a switching element that switches ON-when the scanning signals pass therethrough and a display electrode into which the image signals (analog values) are written. One example of a switching element is a thin film transistor (TFT). In TFTs, the display electrode is opposed to a counter electrode with a liquid crystal layer sandwiched therebetween. The display electrode maintains an electric charge corresponding to the voltage of the image signals (gradation signals). The capacitance of the display electrode is determined by the capacitance of the liquid crystal layer itself or by the capacitance of a storage capacitor after the switching element is switched OFF.

The orientation of liquid crystals disposed at a portion corresponding to the display electrode is adjusted for every dot area in the display of the liquid crystal display apparatus. This adjustment is made in accordance with the amount of the electric charge stored in the display electrode in order to control the gradation of each display device.

Various methods for driving a gate driver are known. With some methods, a scanning line electrically floats at a certain timing, allowing for a voltage to disadvantageously leak from a next scanning line, through a display electrode, and to the floating scanning line.

FIG. 9 is an illustration of the principle of operation of a known liquid crystal display apparatus. A substrate (not shown) of the liquid crystal display apparatus in FIG. 9 has first to third scanning lines G1, G2, and G3 arranged in parallel with each other and display electrodes 11. An insulating film 12 is disposed between the scanning lines G1, G2, and G3 and the display electrodes 11. The liquid crystal display apparatus is provided with pulse applying means 13. For simplicity and clarity, only components required for describing the liquid crystal display apparatus are shown in FIG. 9 and the remaining components are omitted.

In this liquid crystal display apparatus, two neighboring scanning lines, for example, the first scanning line G1 and the second scanning line G2 or the second scanning line G2 and the third scanning line G3, are capacitively coupled with each other via the corresponding display electrode 11. Hence, when a signal is input to the first scanning line G1 next to the second scanning line G2 that is electrically floating to increase the voltage of the first scanning line G1, a voltage leaks into the second scanning line G2, resulting in the increased voltage of the second scanning line G2.

Such an increase in voltage can cause a malfunction of the gate driver and possibly lead to display defects.

### SUMMARY OF THE INVENTION

Accordingly, it is an object of the present invention to provide a liquid crystal display apparatus capable of preventing a malfunction of a gate driver due to voltage leakage from a scanning line next to an electrically-floating scanning line.

The present invention provides, in its first aspect a liquid crystal display apparatus including a first substrate, a second substrate opposed to the first substrate, liquid crystals disposed between the first and second substrates, and a DC power supply. The first substrate has a plurality of scanning lines; a plurality of signal lines, the scanning lines and the signal lines being arranged in a matrix; display electrodes provided in the areas partitioned by the scanning lines and the signal lines; thin film transistors (TFTs) provided in the areas partitioned by the scanning lines and the signal lines and connected to the display electrodes; shield electrodes covering the respective scanning lines at least partly; and an insulating film disposed between the shield electrodes and the scanning lines. The shield electrodes are electrically connected to the DC power supply.

In such a liquid crystal display apparatus, the shield electrode connected to the DC power supply is provided adjacent to the scanning line. Accordingly, even when a first scanning line next to a second scanning line that is floating varies in voltage, the second scanning line does not vary in voltage, thus preventing a malfunction of the gate driver. The second scanning line is sometimes referred to as a floating scanning line, whereas the first scanning line is sometimes referred to as a next scanning line.

The present invention provides, in its second aspect, a liquid crystal display apparatus including a first substrate, a second substrate opposed to the first substrate, liquid crystals disposed between the first and second substrates, and a plurality of reverse-phase pulse-applying units. The first substrate has a plurality of scanning lines; a plurality of signal lines, the scanning lines and the signal lines being arranged in a matrix; display electrodes provided in the areas partitioned by the scanning lines and the signal lines; thin film transistors (TFTs) provided in the areas partitioned by the scanning lines and the signal lines and connected to the display electrodes; shield electrodes covering the respective scanning lines at least partly; and an insulating film disposed between the shield electrodes and the scanning lines. Each reverse-phase pulse-applying unit applies a pulse of a reverse phase with respect to an electrical signal applied to the corresponding scanning line to the corresponding shield electrode. Each shield electrode is electrically connected to the corresponding reverse-phase pulse-applying unit.

In such a liquid crystal display apparatus, the shield electrode connected to the reverse-phase pulse-applying unit is provided adjacent to the scanning line. Accordingly, electrical signals (scanning signals) of the scanning line can be offset with reverse-phase pulses of the shield electrode, thus eliminating the adverse effect of the voltage leakage through the display electrode. This prevents the variation in voltage of the floating scanning line and therefore prevents a malfunction of the gate driver.

At least one capacitor is preferably disposed between the shield electrodes and the DC power supply. A capacitor is preferably disposed between each shield electrode and the corresponding reverse-phase pulse-applying unit.

Use of capacitors between the shield electrodes and the DC power supply and/or between each shield electrode and the corresponding reverse-phase pulse-applying unit helps prevent the gate driver from malfunctioning and the load capacitance of the scanning line to be reduced, thus decreasing the load capacitance of the gate driver and extending the life of the gate driver.

It is preferable that each display electrode be disposed over the corresponding scanning line and each shield electrode be interposed between the corresponding scanning line and the corresponding display electrode in an area where the display electrode is disposed over the scanning line.

Such a structure provides an effect of preventing the gate driver from malfunctioning and allows the shield electrode to be arranged without reduction in area of the display electrode to keep the display electrode large. In particular in a reflective liquid crystal display apparatus that displays images by using reflected outside light, this structure preferably provides a large opening ratio (pixel area/display electrode area).

With this structure, the capacitance (Cgp) between the scanning line and the display electrode can be eliminated. Hence, the voltage drop ΔVp at the display electrode can be reduced, as described below, thus suppressing flicker caused by the voltage drop.

The first substrate of the liquid crystal display apparatus preferably further has shield lines electrically connected to the respective shield electrodes via contact holes. It is preferable that the shield lines be electrically connected to the DC power supply or each shield line be electrically connected to the corresponding reverse-phase pulse-applying unit.

It is also preferable that the shield lines are formed in the same layer (i.e. same process layer) as the scanning lines and the shield electrodes are formed in the same layer as the signal lines. Such a structure provides an effect of preventing the gate-driver from malfunctioning.

Additionally, the shield electrodes can be formed in the process of manufacturing the signal lines and the shield line can be formed in the process of manufacturing the scanning lines. Accordingly, the shield lines and the shield electrodes can be formed without increase in the number of masks or processes, thus reducing the production cost.

In addition, the shield electrodes may be formed in the same layer as the display electrodes. Such a structure provides an effect of preventing the gate driver from malfunctioning.

Additionally, the shield electrodes can be formed in the process of manufacturing the display electrodes and the shield line can be formed in the process of manufacturing the scanning lines. Accordingly, the shield lines and the shield electrodes can be formed without increase in the number of masks or processes, thus reducing the production cost.

The above and other objects, features, and advantages of the present invention will become clear from the following description of the preferred embodiments taken in conjunction with the accompanying drawings.

### BRIEF DESCRIPTION OF THE DRAWINGS

FIG. 1 is a plan view of a bottom substrate included in a liquid crystal display apparatus according to a first embodiment of the present invention;

FIG. 2 is an illustration of the principle of operation of the liquid crystal display apparatus according to the first embodiment;

FIG. 3 is an illustration of the principle of operation of a liquid crystal display apparatus according to a first modification of the first embodiment;

FIG. 4 is an illustration of the principle of operation of a liquid crystal display apparatus according to a second modification of the first embodiment;

FIG. 5 is an illustration of the principle of operation of a liquid crystal display apparatus according to a third modification of the first embodiment;

FIG. 6 is an illustration-of the principle of operation of a liquid crystal display apparatus according to a second embodiment of the present invention;

FIG. 7 is a plan view of a bottom substrate included in a liquid crystal display apparatus according to a third embodiment of the present invention;

FIG. 8 is an enlarged view of part of the bottom substrate in FIG. 7; and

FIG. 9 is an illustration of the principle of operation of a known liquid crystal display apparatus.

### DESCRIPTION OF THE PREFERRED EMBODIMENTS

Embodiments of the present invention will now be described with reference to the attached drawings. The present invention, however, is not limited to the embodiments described below.

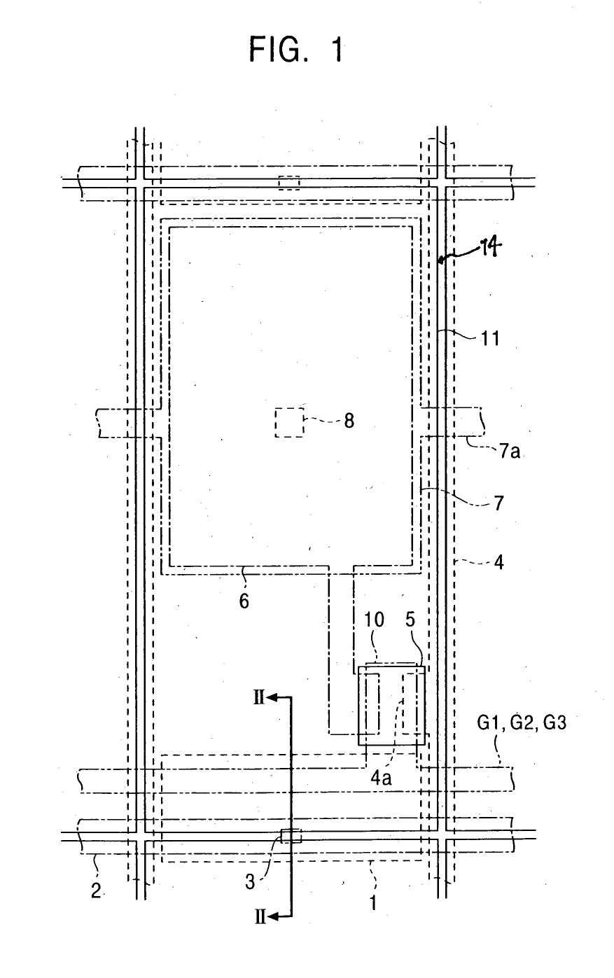

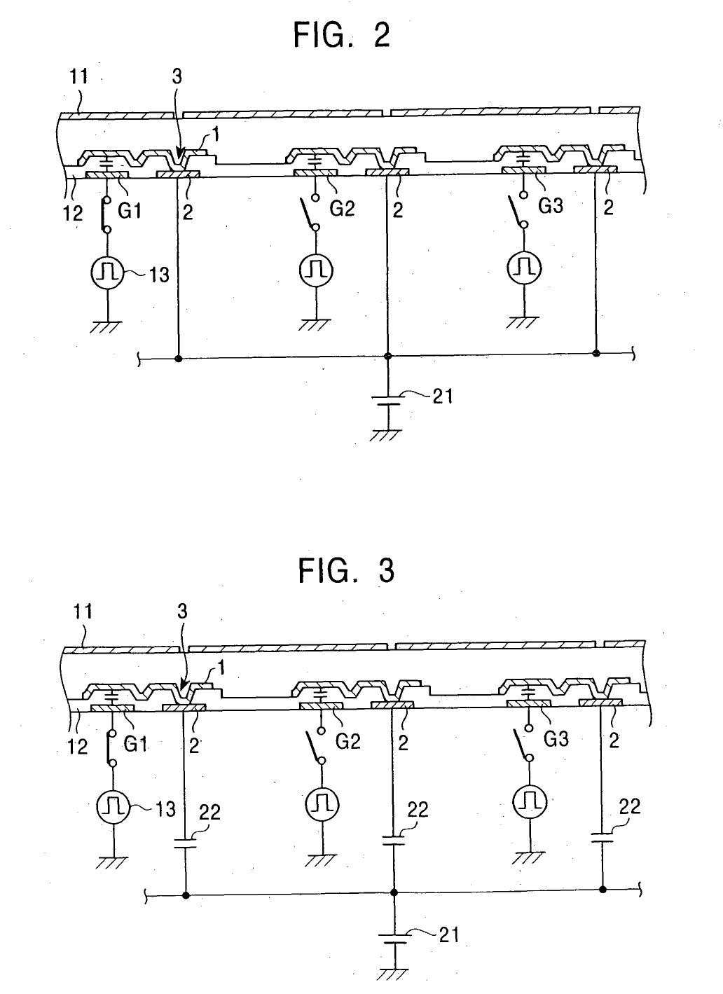

FIG. 1 is a plan view of a bottom substrate included in a liquid crystal display apparatus according to a first embodiment of the present invention. FIG. 2 is an illustration of the principle of operation of the liquid crystal display apparatus. Although FIG. 2 is a sectional view taken on line II-II of FIG. 1, only components required for describing the liquid crystal display apparatus are shown and the remaining components are omitted (this applies to the other illustrations of the principles of operation). Omission of these components is to provide more simple and clear descriptions of the invention and not meant to limit the scope of the invention or the variety of applications for which the invention may be used.

Referring to FIGS. 1 and 2, a plurality of scanning lines G1, G2, G3, . . . and a plurality of signal lines 4 are arranged in a matrix on the bottom substrate (not shown). A display electrode 11 and a thin film transistor (TFT) 5 connected to the display electrode 11 are disposed in each area partitioned by the scanning lines G1, G2, G3, . . . and the signal lines 4.

The bottom substrate of the liquid crystal display apparatus has drain electrodes 6, storage-capacitor electrodes 7, common lines 7a, and contact holes 8, each electrically connecting each drain electrode 6 and the corresponding display electrode 11. The bottom substrate also has gate electrodes 10, each being provided as one continuous electrode with the scanning lines G1, G2, G3, . . . and source electrodes 4a, each being provided as one continuous electrode with the signal lines 4.

Each display electrode 11 is disposed over the corresponding scanning line G1, G2, G3, . . . Shield lines 2 are disposed in the same layer as the scanning lines G1, G2, G3, . . . and extend in parallel with the scanning lines G1, G2, G3, . . . .

Each shield line 2 is provided outside each display area partitioned by scanning lines G1, G2, G3, . . . and the signal lines 4. The display electrode 11 is provided for every area partitioned by the shield lines 2 and the signal lines 4. The area partitioned by the shield lines 2 and the signal lines 4 corresponds to one dot. This area is sometimes referred to as a dot area 14.

The scanning lines G1, G2, G3, . . . and the shield lines 2 are covered with an insulating film 12. Each of the scanning lines G1, G2, G3, . . . and the corresponding shield line 2 in the dot area are almost completely covered with one shield electrode 1. Shield electrodes 1 are disposed between the insulating film 12 and the display electrodes 11 and are provided in the same layer as the signal lines 4. The shield electrodes 1 are electrically connected to the shield lines 2 via contact holes 3. The shield lines 2 are electrically connected to a direct-current (DC) power supply 21.

The scanning lines G1, G2, G3, . . . are electrically connected to the respective pulse applying means 13, and controlled electrical signals are applied to the respective scanning lines G1, G2, G3, . . . .

Typical methods for manufacturing the substrate having the structure described above involve forming the shield lines 2 and the-scanning lines G1, G2, G3, . . . in the same process and are comprised of the same material. Conventionally, the insulating films 12 are then formed, and then the shield electrodes 1 and the scanning lines 4 are formed in the same process and of the same material.

Since each shield electrode 1 is disposed between each of the scanning lines G1, G2, G3, . . . and the display electrode 11 in this first embodiment, each of the scanning lines G1, G2, G3, . . . is capacitively coupled with the shield electrode 1 but is not capacitively coupled with the display electrode 11. Additionally, the shield electrode 1 is electrically connected to the DC power supply 21 through the shield line 2. Hence, even when each of the scanning lines G1, G2, G3, . . . varies in voltage, the voltage of the corresponding shield electrode 1 is maintained at a certain value. Accordingly, for example, when one scanning line G2 is floating and the next scanning line G1 varies in voltage, the voltage at the floating scanning line G2 does not vary, thus preventing a malfunction of a gate driver.

Disposing the shield electrode 1 between each of the scanning lines G1, G2, G3, . . . and the corresponding display electrode 11 allows the display electrode 11 in the dot area to have a sufficient size.

In a traditional liquid crystal display apparatus, variation of a gate voltage Vg to switch off a TFT generally causes charge distribution between the capacitance of a liquid crystal layer disposed between a pair of substrates, the parasitic capacitance (Cgp) between a scanning line and a display electrode, the parasitic capacitance of the TFT, and so on. This cascade of charge distributions leads to a dynamic voltage drop (ΔVp) at the display electrode. When the voltage drop (ΔVp) occurs at the display electrode, a positive voltage level of the voltage (Vp) of the display electrode differs from a negative voltage level thereof. When voltages having the same absolute value independent of their voltage polarity are applied to liquid crystals, the liquid crystals have a certain transmittance. Hence, for example, an active matrix liquid crystal display apparatus in a normally white mode that has high transmittance without an applied voltage exhibits lower transmittance with larger voltage swing and higher transmittance with smaller voltage swing. These swings induce repeated changes in brightness in accordance with the transmittance and are visually recognized as flicker.

In contrast, in the liquid crystal display apparatus according to the embodiment of the present invention, no capacitive coupling occurs between the scanning lines G1, G2, G3, . . . and the display electrodes 11 to generate no parasitic capacitance (Cgp). Accordingly, the voltage drop (ΔVp) at the display electrode 11 can be reduced to suppress the flicker.

FIGS. 3 to 5 show three modifications of the first embodiment of the present invention.

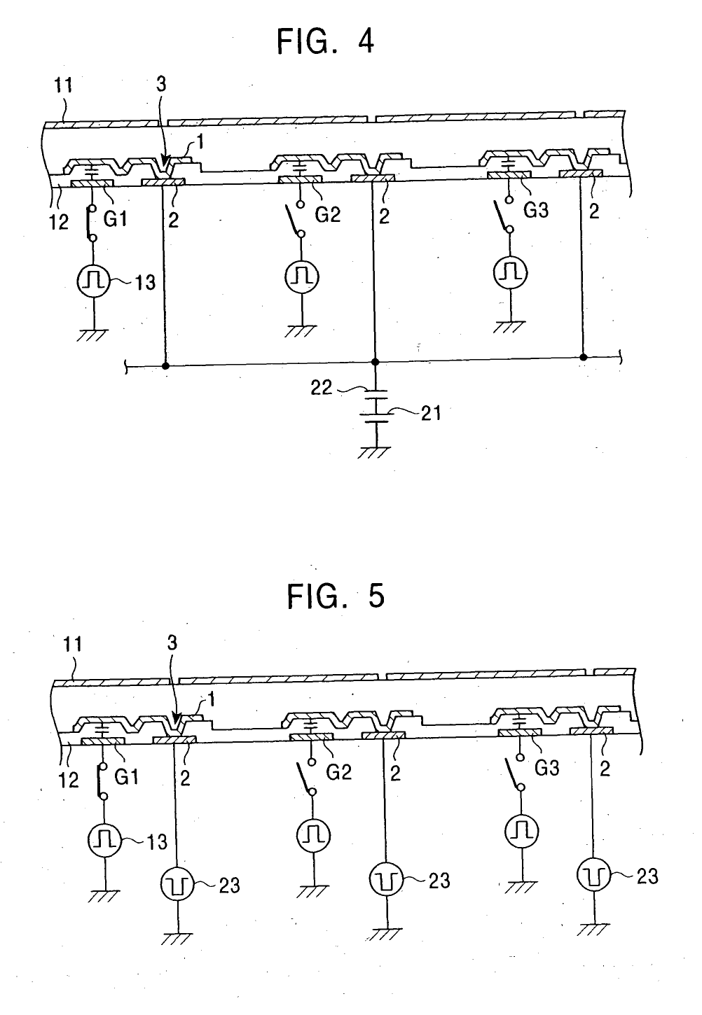

In the liquid crystal display apparatus according to a first modification of the first embodiment in FIG. 3, a plurality of capacitors 22 are disposed in parallel between the shield lines 2 and the DC power supply 21. One capacitor 22 is provided for every shield line 2. In the liquid crystal display apparatus according to a second modification in FIG. 4, one capacitor 22 is provided between the shield lines 2 and the DC power supply 21.

In both the first modification and the second modification, disposing the capacitor 22 between the shield electrode 1 that is capacitively coupled with each of the scanning lines G1, G2, G3, . . . and the DC power supply 21 allows the load capacitance of scanning lines G1, G2, G3, . . . to decrease.

In a third modification of the first embodiment in FIG. 5, reverse-phase pulse-applying means 23 are provided instead of the DC power supply 21. The reverse-phase pulse-applying means 23 applies a pulse to the shield electrode 1, which covers the next scanning line G1, through the corresponding shield line 2. This pulse has a reverse phase with respect to an electrical signal applied to the next scanning line G1 of the floating scanning line G2.

In the third modification of the first embodiment, the shield electrode 1 disposed between each of the scanning lines G1, G2, G3, . . . and the corresponding display electrode 11 is electrically connected to the reverse-phase pulse-applying means 23 through the shield line 2. When an electrical signal (scanning signal) is applied to the next scanning line G1 of the floating scanning line G2, voltage leakage from the next scanning line G1 to the floating scanning line G2 can occur via the display electrode 11, whereas the pulse of the reverse phase with respect to the electrical signal applied to the next scanning line G1 is applied to the shield electrode 1 covering the scanning line G1 through the shield line 2. Accordingly, the voltage leakage is compensated by the applied pulse of the reverse phase, thus preventing a change in voltage at the floating scanning line G2 via the display electrode 11.

In this modification, a capacitor may be disposed between the shield line 2 and the reverse-phase pulse-applying means 23 as in the first and second modifications for achieving the same effect.

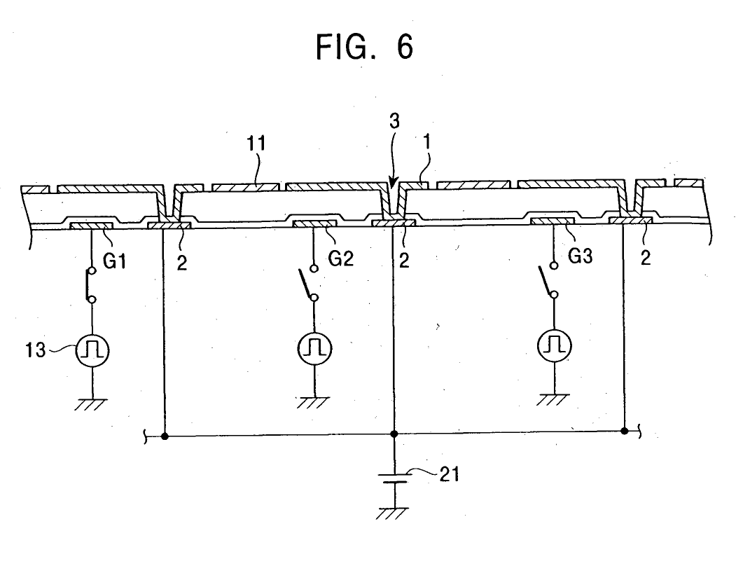

FIG. 6 is an illustration of the principle of operation of a liquid crystal display apparatus according to a second embodiment of the present invention.

A bottom substrate of the liquid crystal display apparatus of the second embodiment differs from that of the first embodiment in that the shield electrodes 1 are provided in the same layer as the display electrodes 11.

Each shield electrode 1, which is formed in the same layer as the corresponding display electrode 11, covers each of the scanning lines G1, G2, G3, . . . and the corresponding shield line 2 in one dot area. The display electrode 11 is not disposed over each of the scanning lines G1, G2, G3, . . . .

The shield electrode 1 is electrically connected to the shield line 2 via the contact hole 3. The shield line 2 is electrically connected to the DC power supply 21.

In order to manufacture the substrate having the structure described above by using a known method, the shield lines 2 and the scanning lines G1, G2, G3, . . . are formed in the same process and of the same material, the insulating films 12, the signal lines 4, and so on are sequentially formed, and then the shield electrodes 1 and the display electrode 11 are formed in the same process and of the same material.

Since the shield electrodes 1 are not disposed between the scanning lines G1, G2, G3, . . . and the display electrodes 11, the capacitive coupling between each of the scanning lines G1, G2, G3, . . . and the corresponding display electrode 11 cannot be eliminated. However, the shield electrode 1 is nearer-to each of the scanning lines G1, G2, G3, . . . than the display electrode 11, so that most of the electric lines of force starting from the scanning lines G1, G2, G3, . . . terminate at the shield electrode 1.

Accordingly, although the voltage drop ΔVp at the shield electrode 1 is not reduced (the flicker is not eliminated), unlike the first embodiment, the other effects of the first embodiment are achieved. Furthermore, the load capacitance of the scanning lines G1, G2, G3, . . . is more greatly reduced in this second embodiment, compared with the first embodiment, and therefore the load capacitance of the gate driver is decreased, thus extending the life of the gate driver.

The same modifications as the first embodiment may be employed in this second embodiment.

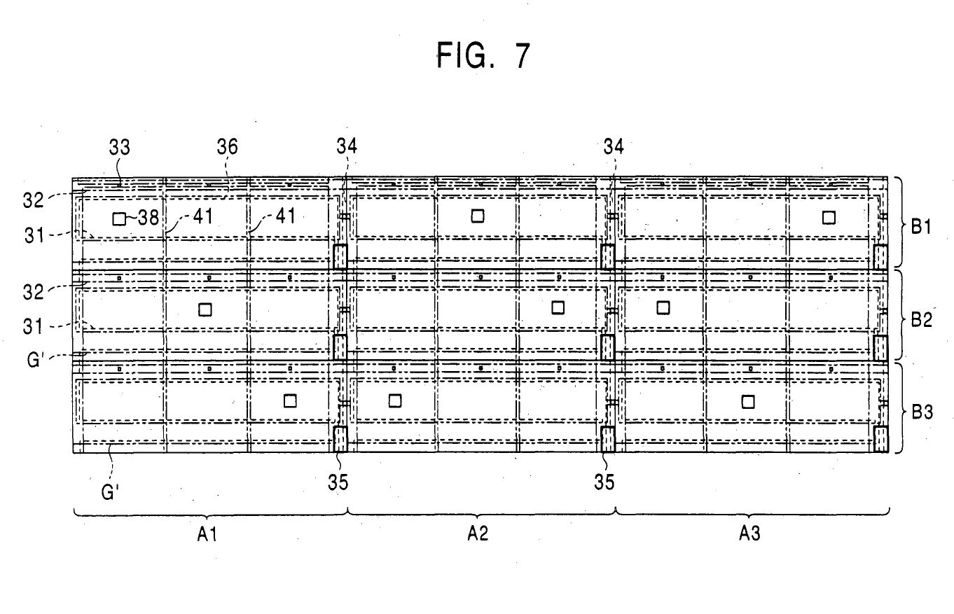

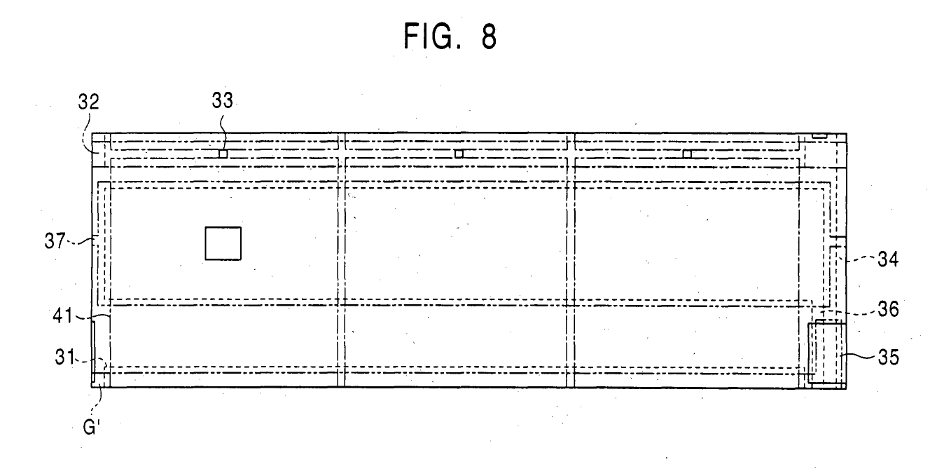

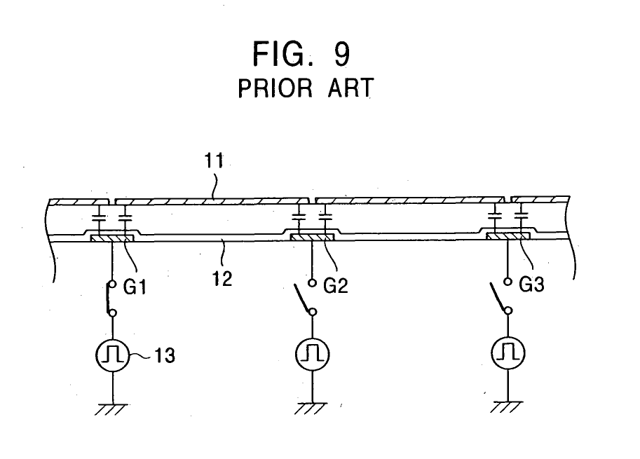

FIGS. 7 and 8 include plan views of the bottom substrate of a liquid crystal display apparatus according to a third embodiment of the present invention. While the planar layout of the electrodes and lines of the liquid crystal display apparatus in the third embodiment differs from that in the first embodiment, the sectional structure and other structures in the third embodiment are, although changed in accordance with the planar structure, almost the same as those in the first embodiment. FIG. 7 shows three pixels A1, A2, and A3. Each of the pixels A1, A2, and A3 is substantially square and contains three dot areas B1, B2, and B3. FIG. 8 is an enlarged view of one dot area in FIG. 7.

A plurality of scanning lines G′ and a plurality of signal lines 34 are arranged in a matrix on the substrate of the liquid crystal display apparatus of the third embodiment. Each rectangular dot area partitioned by the scanning lines G′ and the signal lines 34 has long sides along the scanning lines G′ and narrow sides along the signal lines 34. Each dot area contains a TFT 35 connected to each intersection point of the scanning lines G′ and the signal lines 34 and a drain electrode 36 connected to the TFT 35. The drain electrode 36 also serves as a storage-capacitor electrode. An insulating film (not shown), is formed on the drain electrodes 36 and display electrodes 41 are disposed over the insulating film. Each display electrode 41 is electrically connected to the corresponding drain electrode 36 via a contact hole 38 formed in the insulating film.

The drain electrodes 36 extend along the scanning lines G′. Each drain electrode 36 is provided for every dot area. In contrast, the display electrodes 41 extend along the signal lines 34. Each display electrode 41 is provided across three dot areas. Accordingly, three one-third display electrodes 41 are present in one dot area in FIG. 8. One display electrode 41 is electrically connected only to one drain electrode 36 and one drain electrode 36 is electrically connected only to one display electrode 41. The bottom substrate is also provided with common lines 37.

Shield lines 32 extend in parallel with the scanning lines G′. Each shield electrode 31 covers the scanning line G′ and the almost entire shield line 32 in each dot area. The shield lines 32 are disposed in the same layer as the scanning lines G′ and the shield electrodes 31 are disposed in the same layer as the signal lines 34. Each shield electrode 31 is electrically connected to the corresponding shield line 32 via a contact hole 33. The shield lines 32 are electrically connected to a DC power supply (not shown) and each of the scanning lines G′ is electrically connected to pulse-applying means (not shown).

What is claimed is:

1. A liquid crystal display apparatus comprising:
a first substrate having:
a plurality of scanning lines;
a plurality of signal lines, wherein the scanning lines and the signal lines being arranged in a matrix;
a plurality of display electrodes provided in the areas partitioned by the scanning lines and the signal lines;
a plurality of thin film transistors (TFTs) provided in the areas partitioned by the scanning lines and the signal lines and connected to the display electrodes;
a plurality of shield electrodes, wherein each shield electrode at least partially covers a corresponding scanning line; and
an insulating film disposed between the shield electrodes and the scanning lines;
a second substrate opposed to the first substrate;
liquid crystals disposed between the first and second substrates; and
a DC power supply electrically connected to at least one of the plurality of shield electrodes.

2. A liquid crystal display apparatus comprising:
a first substrate having:
a plurality of scanning lines;
a plurality of signal lines, the scanning lines and the signal lines being arranged in a matrix;
a plurality of display electrodes provided in the areas partitioned by the scanning lines and the signal lines;
a plurality of thin film transistors (TFTs) provided in the areas partitioned by the scanning lines and the signal lines and connected to the display electrodes;
a plurality of shield electrodes covering the respective scanning lines at least partly; and
an insulating film disposed between the shield electrodes and the scanning lines;
a second substrate opposed to the first substrate;
liquid crystals disposed between the first and second substrates; and
a plurality of reverse-phase pulse-applying units, each of which applies a pulse having a reverse phase with respect to an electrical signal applied to a corresponding scanning line and to a corresponding shield electrode, each shield electrode being electrically connected to a corresponding reverse-phase pulse-applying unit.

3. A liquid crystal display apparatus according to claim 1, wherein at least one capacitor is disposed between at least one of the plurality of shield electrodes and the DC power supply.

4. A liquid crystal display apparatus according to claim 2, wherein a plurality of capacitors are disposed between the plurality of shield electrodes and the plurality of reverse-phase pulse-applying units.

5. A liquid crystal display apparatus according to claim 1,
wherein each display electrode is disposed over a corresponding scanning line, and
wherein each shield electrode is interposed between a corresponding scanning line and a corresponding display electrode in an area where a display electrode is disposed over a corresponding scanning line.

6. A liquid crystal display apparatus according to claim 2,
wherein each display electrode is disposed over a corresponding scanning line, and
wherein each shield electrode is interposed between a corresponding scanning line and a corresponding display electrode in an area where a display electrode is disposed over a corresponding scanning line.

7. A liquid crystal display apparatus according to claim 1, wherein the first substrate further has contact holes,
wherein each shield line is electrically connected to a respective shield electrode via a respective contact hole,
wherein the shield lines are electrically connected to the DC power supply, and
wherein the shield lines are formed in the same layer where the scanning lines are formed and the shield electrodes are formed in the same layer where the signal lines are formed.

8. A liquid crystal display apparatus according to claim 2, wherein the first substrate further has contact holes,
wherein each shield line is electrically connected to a respective shield electrode via a respective contact hole,
wherein each shield line is electrically connected to the corresponding reverse-phase pulse-applying unit, and
wherein the shield lines are formed in the same layer where the scanning lines are formed and the shield electrodes are formed in the same layer where the signal lines are formed.

9. A liquid crystal display apparatus according to claim 1, wherein each of the plurality of shield lines is electrically connected to a corresponding shield electrode via a contact hole of the first substrate,
wherein the plurality of shield lines are electrically connected to the DC power supply, and
wherein the plurality of shield lines are formed in the same layer as the scanning lines are formed and the shield electrodes are formed in the same layer as the display electrodes are formed.

10. A liquid crystal display apparatus according to claim 2, wherein each of the plurality of shield lines is electrically connected to a corresponding shield electrode via a contact hole,
wherein each of the plurality of shield lines is electrically connected to a corresponding reverse phase pulse-applying unit, and
wherein the plurality of shield lines are formed in the same layer as the scanning lines are formed and the shield electrodes are formed in the same layer as the display electrodes are formed.

11. A liquid crystal display apparatus according to claim 1, wherein at least one of the plurality of scanning lines is capacitively coupled with at least one of the plurality of display electrodes.

12. A liquid crystal display apparatus according to claim 1, wherein each of the plurality of scanning lines is capacitively coupled with each of the plurality of display electrodes.

13. In a liquid crystal display having at least two adjacent scanning lines, a method of capacitively decoupling the adjacent scanning lines comprising:
applying a first signal having a first phase to one of the adjacent scanning lines; and applying a second signal having a second phase to a shield line positioned between the adjacent scanning lines thereby providing a current path that substantially capacitively decouples the adjacent scanning lines.

14. A method according to claim 13, wherein the second phase is reverse of the first phase.

15. A method according to claim 13, wherein the second signal is at ground.
